(19) United States
(12) Patent Application Publication
(10) Pub. No.: US 2009/0187433 A1
(43) Pub. Date: Jul. 23, 2009

(54) System for providing insurance associated with a lost-and-found service

(76) Inventor: Geoffrey H. Nudd, San Francisco, CA (US)

Correspondence Address: William C. Milks, III, 401 Florence Street, Palo Alto, CA, 94301, US

(21) Appl. No.: 12/319,671

(22) Filed: Jan. 8, 2009

Related U.S. Application Data
(60) Provisional application No. 61/011,590, filed on Jan. 18, 2008.
(60) Provisional application No. 61/011,591, filed on Jan. 18, 2008.
(60) Provisional application No. 61/011,594, filed on Jan. 18, 2008.
(60) Provisional application No. 61/011,595, filed on Jan. 18, 2008.
(60) Provisional application No. 61/011,617, filed on Jan. 18, 2008.
(60) Provisional application No. 61/011,620, filed on Jan. 18, 2008.
(60) Provisional application No. 61/011,676, filed on Jan. 18, 2008.

(51) Int. Cl. G06Q 40/00

(52) U.S. Cl. 705/4

(57) ABSTRACT

A system for providing insurance associated with a lost-and-found service, according to which a person and/or item (the “insured”) is covered by an insurance policy that provides compensation in the event of at least one of loss, theft, damage, and/or destruction of an item, and in association with said insurance, also receives one or more services that facilitate the return of the item if it is lost or stolen. The insurance policy pays for the facilitation of the return of an item if it is lost by the insured and subsequently found and reported to a lost-and-found service provider. The insured pays the insurance provider a deductible for the return of the previously insured and/or lost item. Also, a lost-and-found service provider is reimbursed by the insurance provider when an item is lost in exchange for providing the services of identifying the insured using unique markings contained on a lost item owned by the insured, contacting the person associated with the item, contacting the insurance service provider (which may or may not be the same as the lost-and-found service provider), and/or facilitating the return of the lost item to the owner or insurance provider. Registering for an insurance policy also facilitates registering for the services of a lost-and-found service provider.

### CROSS-REFERENCE TO RELATED APPLICATIONS

This application relates to U.S. Provisional Patent Applications No. 61/011,590 filed on Jan. 18, 2008, entitled SYSTEMS AND METHODS FOR NOTIFYING AN OWNER ABOUT A FOUND ITEM IN A LOST-AND-FOUND SERVICE, No. 61/011,591 filed on Jan. 18, 2008, entitled SYSTEM FOR MANAGING EXCEPTIONS ASSOCIATED WITH A LOST-AND-FOUND SERVICE, No. 61/011,594 filed on Jan. 18, 2008, entitled SYSTEMS AND METHODS FOR PROVIDING INCENTIVES IN A LOST-AND-FOUND SYSTEM, 61/011,595 filed on Jan. 18, 2008, entitled LOST AND FOUND COMBINED LABEL AND REGISTRATION, No. 61/011,617 filed on Jan. 18, 2008, entitled CALL CENTER AND FULFILLMENT CENTER FOR A LOST-AND-FOUND SYSTEM, No. 61/011,620 filed on Jan. 18, 2008, entitled SYSTEM FOR PROVIDING INSURANCE ASSOCIATED WITH A LOST-AND-FOUND SERVICE, and No. 61/011,676 filed on Jan. 18, 2008, entitled ENVELOPE AND SYSTEM FOR RETURNING LOST ITEMS, the disclosures of which are hereby incorporated herein in their entirety by this reference.

### BACKGROUND OF THE INVENTION

1. Field of the Invention

The present invention relates to a system for providing insurance associated with a lost-and-found service.

2. Description of the Prior Art

References Cited
U.S. Patent Documents

| | | |
|---|---|---|
| 4,271,352 | June 1981 | Thomas |
| 5,180,192 | January 1993 | Herbert |
| 5,732,401 | March 1998 | Conway |
| 5,809,481 | September 1998 | Baron, et al. |
| 5,841,116 | November 1998 | Lewis |
| WO1999018818 | April 1999 | Biles |
| 5,933,829 | August 1999 | Durst |
| 5,936,527 | August 1999 | Isaacman |
| 5,949,335 | September 1999 | Maynard |
| 5,955,965 | September 1999 | Colandruccio |
| 5,962,834 | October 1999 | Markman |
| 6,025,780 | February 2000 | Bowers, et al. |
| 6,040,774 | March 2000 | Schepps |
| 6,259,367 | July 2001 | Klein |
| US20030083939 | October 2001 | Klein |
| US20010037248 | November 2001 | Klein |
| US20010053981 | December 2001 | Wyssen |
| 6,025,780 | February 2002 | Bowers |
| 6,449,611 | September 2002 | Frankel, et al. |
| WO2002084615 | October 2002 | Klein |
| 6,533,172 | March 2003 | Popp |
| 6,546,088 | April 2003 | Campbell |
| US20030083939 | May 2003 | Wohl |
| US20030194079 | October 2003 | Scott |
| 20030182140 | September 2003 | Furuya, et al. |
| 6,662,078 | December 2003 | Hardgrave, et al. |
| US20040019609 | January 2004 | Orton, et al. |
| US20040002998 | January 2004 | Takahashi, et al.. |
| 6,747,560 | June 2004 | Stevens |
| US20040124239 | July 2004 | Feld |
| US20050035860 | February 2005 | Taylor, et al. |
| 6,965,866 | March 2005 | Klein |
| 6,967,577 | November 2005 | Stanton, et al. |
| US20060028343 | February 2006 | Taylor |
| US20060087440 | April 2006 | Klein |
| US20060148443 | July 2006 | Bernard |
| 7,135,977 | November 2006 | Bernard, et al. |
| US20060265298 | November 2006 | Lee |
| US20060282325 | December 2006 | Martin |
| WO2007045992 | April 2007 | Hosp, et al. |
| 7,210,625 | May 2007 | McNutt, et al. |
| 7,230,534 | June 2007 | Elledge |
| 7,259,680 | August 2007 | Popp |
| US20070214021 | September 2007 | McLaughlin |
| US20070252697 | November 2007 | Elledge |

The sale of insurance for lost, stolen, and/or damaged items has become widespread in the marketplace for items such as mobile phones, personal digital assistants (PDAs), digital cameras, laptop computers, and other items. This insurance is sold by retailers such as Circuit City (www.circuitcity.com) and Best Buy (www.bestbuy.com) and also by mobile phone telecommunications carriers such as Verizon (www.verizon.com) and Cingular (www.cingular.com). However, a major problem with known insurance offerings is that many of the insured items are essentially irreplaceable in that they contain data that is unique to the item and/or its owner. By way of example, mobile phones and PDAs often contain contact and/or calendar information of their owners, digital cameras often contain important photos belonging to their owners, and laptops often contain a variety of data that is valuable and important to their owners. Therefore, while such insurance provides some compensation in the event of loss or theft of an item, it does not solve the problem of returning the data to the item's owner.

Lost-and-found services are described in the prior art, but no large and/or prevalent lost-and-found service provider has emerged in the marketplace to date. In part, this is because lost-and-found services face difficulties when charging clients for return of a found item and/or rewarding an item finder for facilitating the return of a lost item.

Looking now to lost-and-found service providers, another problem is that prior apparatuses, methods, and systems provide ambiguous and/or weak incentives for the finder to return items. Incentives for item finders who return the items are mentioned at a high level in the prior art, but the prior art lacks an enabled method and apparatus for practically and realistically providing such an incentive.

Another problem relates to the purchase of such a lost-and-found service, and means to make it easy for an item owner to purchase assurances that such a service will be provided for an item. These assurances are preferably made to the item owner by the lost-and-found service provider in a retail environment in a fast and convenient manner. However, such assurances have to date not been practically offered and adopted in a widespread manner in the marketplace.

For example, Herbert, U.S. Pat. No. 5,180,192 proposes a mailable card containing (a) the address of a central registry, (b) a peel-off and reaffixable adhesive label upon which can be written the name and mailing address of a registrant, (c) a peel-off and reaffixable adhesive label upon which appears a barcode label identifier, and (d) a printed barcode matching said barcode label identifier. This patent does not disclose an insurance offering associated the proposed system, nor does it disclose means to make it easy to provide an incentive to a finder for facilitating the return of an item, nor does it disclose means to make it easy for an item owner to obtain assurances that a lost-and-found service will be provided for an item if lost.

Feld, U.S. Pat. App. US2004/0124239A1 discloses a system for tagging items, registering information about the tag and the item, and facilitating the return of the item if lost. However, it does not disclose an insurance offering associated with the system's use, nor does it disclose means to make it easy to provide an incentive to a finder for facilitating the return of an item, nor does it disclose means to make it easy for an item owner to obtain assurances that a lost-and-found service will be provided for an item if lost.

Stanton, U.S. Pat. No. 6,967,577 also discloses a system and method for tagging items, registering information about the tag and the item, and facilitating the return of the item if lost. However, it does not disclose an insurance offering associated with the system and/or method's use, nor does it disclose means to make it easy to provide an incentive to a finder for facilitating the return of an item, nor does it disclose means to make it easy for an item owner to obtain assurances that a lost-and-found service will be provided for an item if lost.

Klein, U.S. Pat. No. 6,259,367 also discloses a system and method for tagging items, registering information about the tag and the item, and facilitating the return of the item if lost. In particular, it proposes use of an RFID which carries many of the same burdens as the bar code apparatus as aforementioned. However, it does not disclose an insurance offering associated with the system and/or method's use, nor does it disclose means to make it easy to provide an incentive to a finder for facilitating the return of an item, nor does it disclose means to make it easy for an item owner to obtain assurances that a lost-and-found service will be provided for an item if lost.

Lewis, U.S. Pat. No. 5,841,116 also discloses a system and method for tagging items, registering information about the tag and the item, and facilitating the return of the item if lost. However, it does not disclose an insurance offering associated with the system and/or method's use, nor does it disclose means to make it easy to provide an incentive to a finder for facilitating the return of an item, nor does it disclose means to make it easy for an item owner to obtain assurances that a lost-and-found service will be provided for an item if lost.

McNutt, U.S. Pat. No. 7,210,625 also discloses a system and method for tagging items, registering information about the tag and the item, and facilitating the return of the item if lost. However, it does not disclose an insurance offering associated with the system and/or method's use, nor does it disclose means to make it easy to provide an incentive to a finder for facilitating the return of an item, nor does it disclose means to make it easy for an item owner to obtain assurances that a lost-and-found service will be provided for an item if lost.

Elledge, U.S. Pat. No. 7,230,534 also discloses a system and method for tagging items, registering information about the tag and the item, facilitating the return of the item if lost, and creating an alarm if certain conditions are met relative to an RFID tag and an RFID reader. In particular, it proposes use of an RFID which carries many of the same burdens as the bar code apparatus as aforementioned. Also, it does not disclose an insurance offering associated with the system's use, nor does it disclose means to make it easy to provide an incentive to a finder for facilitating the return of an item, nor does it disclose means to make it easy for an item owner to obtain assurances that a lost-and-found service will be provided for an item if lost.

Taylor, U.S. Pat. App. No. US2006/0028343 and US2005/0035860 also disclose a system and method for tagging items, registering information about the tag and the item, and facilitating the return of the item if lost. In particular, these propose use of an RFID which carries many of the same burdens as the bar code apparatus as aforementioned. Also, it does not disclose an insurance offering associated the system and/or method's use, nor does it disclose means to make it easy to provide an incentive to a finder for facilitating the return of an item, nor does it disclose means to make it easy for an item owner to obtain assurances that a lost-and-found service will be provided for an item if lost.

Frankel, U.S. Pat. No. 6,449,611 discloses a registry for items which have been lost and/or stolen. However, it does not present aspects relative to the tag and/or registration card and related systems and processes that address the aforementioned problems. Also, it does not disclose an insurance offering associated with the registry's use, nor does it disclose means to make it easy to provide an incentive to a finder for facilitating the return of an item, nor does it disclose means to make it easy for an item owner to obtain assurances that a lost-and-found service will be provided for an item if lost.

Takahashi, U.S. Pat. App. No. US/20040002998 discloses a server for managing information about lost items. However, it does not disclose an insurance offering associated with the server's use, nor does it disclose means to make it easy to provide an incentive to a finder for facilitating the return of an item, nor does it disclose means to make it easy for an item owner to obtain assurances that a lost-and-found service will be provided for an item if lost.

Wyssen, U.S. Pat. App. No. US2001/0053981A1 discloses a system and method for retrieving a digital identifier online, registering online, and printing a label with the identifier at a distributed printing location. This system introduces elements for registering information about an item and/or owner and for creating a tag and/or label to facilitate the return of an item that is lost or stolen. However, the proposed system and method have significant disadvantages including that they require online access and/or special printing equipment and software to print the labels. These additional process steps introduce cost, work, and inconvenience to the process and are likely to deter broad adoption. Furthermore, it does not disclose an insurance offering associated with the system's use, nor does it disclose means to make it easy to provide an incentive to a finder for facilitating the return of an item, nor does it disclose means to make it easy for an item owner to obtain assurances that a lost-and-found service will be provided for an item if lost.

Klein, WO2002/084615A1 also discloses a system and method for tagging items, registering information about the tag and the item, and facilitating the return of the item if lost. In particular, it proposes use of an RFID which carries many of the same burdens as the bar code apparatus as aforementioned. Also, it does not disclose an insurance offering associated with the system and/or method's use, nor does it disclose means to make it easy to provide an incentive to a finder for facilitating the return of an item, nor does it disclose means to make it easy for an item owner to obtain assurances that a lost-and-found service will be provided for an item if lost.

Martin, U.S. Pat. App. No. US2006/0282325 discloses a system and method of doing business in which identifying tags are sold which guarantee the return of an item that is marked with the identifying tag by a service provider. However, this disclosure does not present aspects relative to the tag and/or registration card and related systems and processes. Furthermore, it becomes clear in the practice of offering a lost-and-found service that it is generally impractical to offer a guarantee of item return because of many exceptions which can occur related to incentives to the finder, fraud prevention, theft, logistics challenges, item owner preferences, and other exceptions. Furthermore, it does not disclose an insurance offering associated with the system's use, nor does it disclose and enable means to make it easy to provide an incentive to a finder for facilitating the return of an item.

Scott, U.S. Pat. App. No. US2003/0194079 discloses a method and system for registering an identifying tag online as part of an item and item owner registration process, and in a preferred embodiment printing a label and/or tag which can be affixed to the item to assist in its return if lost. However, like Wyssen, U.S. Pat. App. No. US2001/0053981, the proposed method and system have significant disadvantages including that they require online access and/or special printing equipment and software to print the labels. These additional process steps introduce cost, work, and inconvenience to the process and are likely to deter broad adoption. Furthermore, it does not disclose an insurance offering associated with the system and/or method's use, nor does it disclose means to make it easy to provide an incentive to a finder for facilitating the return of an item, nor does it disclose means to make it easy for an item owner to obtain assurances that a lost-and-found service will be provided for an item if lost.

Klein, U.S. Pat. No. 6,965,866 discloses a method for registering an identifying tag as part of a warranty registration process and using the tag to facilitate repair service as part of the warranty. Tangentially, the disclosure describes a method for using this registration to facilitate the return of an item if it is lost. However, the methods disclosed do not suggest means for promoting the use of the tag and/or registering the item outside of the warranty process. A warranty is designed to provide assurances as to the repair to damage and/or defectiveness of an item and/or replacement of a defective item. A warranty is different than insurance for loss and/or theft of an item.

Furthermore, the methods disclosed in the '866 patent require use of an RFID tag which has the aforementioned disadvantages. Finally, the method proposed requires substantial system, process, operational, and technology changes for manufacturers, retailers, and couriers that are involved in core warranty aspects of the proposed method, as well as the tangential lost-and-found methods disclosed. The '866 patent does not disclose an insurance offering associated the system's use, nor does it disclose and enable means to make it easy to provide an incentive to a finder for facilitating the return of an item.

Thomas, U.S. Pat. No. 6,546,088 discloses a system for identifying and restoring an object to an owner who has lost the object, comprising: a tag that is affixed to the object that includes a pre-assigned identification number associated with the owner and a toll-free telephone number; a call center that contacts the owner in response to a call to the toll-free telephone number receiving the pre-assigned identification number from a finder and enabling the owner to receive information regarding the object after entering an owner personal identification number, wherein the system automatically enters the finder in a lottery for a predetermined prize. However, it does not disclose an insurance offering associated with the system's use, nor does it disclose means to make it easy to provide an incentive to a finder for facilitating the return of an item, nor does it disclose means to make it easy for an item owner to obtain assurances that a lost-and-found service will be provided for an item if lost.

Klein, U.S. Pat. App. No. 2006/0087440A1 discloses an animal tag including an RFID tag designed to facilitate the return of a lost pet. The focus of the disclosure on pets makes the apparatus disclosed impractical and suboptimal for use on electrical devices and other items. Additionally, it proposes use of an RFID which carries many of the same burdens as the bar code apparatus as aforementioned. It does not disclose an insurance offering associated with the tag's use, nor does it disclose means to make it easy to provide an incentive to a finder for facilitating the return of an item, nor does it disclose means to make it easy for an item owner to obtain assurances that a lost-and-found service will be provided for an item if lost.

Thomas, U.S. Pat. No. 4,271,352 discloses a method for encoding item and item owner information onto a tag for use in returning the item if lost to its owner. However, it does not disclose an insurance offering associated with the method's use, nor does it disclose means to make it easy to provide an incentive to a finder for facilitating the return of an item, nor does it disclose means to make it easy for an item owner to obtain assurances that a lost-and-found service will be provided for an item if lost.

Hardgrave, U.S. Pat. No. 6,662,078 discloses a system for tracking items such as passenger baggage including elements such as check-in stations, registration servers, and other elements. However, it does not disclose an insurance offering associated with the system's use, nor does it disclose means to make it easy to provide an incentive to a finder for facilitating the return of an item, nor does it disclose means to make it easy for an item owner to obtain assurances that a lost-and-found service will be provided for an item if lost.

Popp, U.S. Pats. No. 6,533,172 and 7,259,680 disclose methods for determining the unique identifier that is placed on a tag used in a lost-and-found service. However, they do not disclose an insurance offering associated with the methods' use, nor do they disclose means to make it easy to provide an incentive to a finder for facilitating the return of an item, nor do they disclose means to make it easy for an item owner to obtain assurances that a lost-and-found service will be provided for an item if lost.

Orton, U.S. Pat. App. No. 2004/0019609 discloses a registry for items which have been lost and/or stolen and a preferred technological implementation of a requisite database. However, it does not present aspects relative to the tag and/or registration card and related systems and processes that address the aforementioned problems. Also, it does not disclose an insurance offering associated with the registry's use, nor does it disclose means to make it easy to provide an incentive to a finder for facilitating the return of an item, nor does it disclose means to make it easy for an item owner to obtain assurances that a lost-and-found service will be provided for an item if lost.

Furuya, U.S. Pat. App. No. 2003/0182140 also discloses a registry for items which have been lost and/or stolen, as well as a method for registering items at the point-of-purchase. The system disclosed proposes storing information about the item and its purchaser at the point-of-purchase using electronic integration of systems of the registry provider and the retailer and/or credit card information system provider. This approach to registration has the disadvantages of significant technological change on the part of the various entities involved. It also threatens to remove privacy from the item purchaser. Also, it does not disclose an insurance offering associated with the system and/or registry's use, nor does it disclose means to make it easy to provide an incentive to a finder for facilitating the return of an item, nor does it disclose means to make it easy for an item owner to obtain assurances that a lost-and-found service will be provided for an item if lost.

Wohl, U.S. Pat. App. No. 2003/0083939 discloses a system for marketing to item owners as part of a lost-and-found service. It does not disclose an insurance offering associated with the system's use, nor does it disclose means to make it easy to provide an incentive to a finder for facilitating the return of an item, nor does it disclose means to make it easy for an item owner to obtain assurances that a lost-and-found service will be provided for an item if lost.

Klein, U.S. Pat. App. No. 2001/0027401 and U.S. Pat. App. No. 2001/0037248 disclose a method for using a lost-and-found service offering as an incentive for completing warranty registration information. There are marked differences in requirements for a warranty system as opposed to one associated with insurance for loss and/or theft of one or more items. Specifically, other than using a lost-and-found service as an incentive to register a product, the disclosures do not describe how the tag and/or registration card and related systems and processes address the aforementioned problems. Furthermore, Klein does not disclose an insurance offering associated with the method's use, nor does it disclose and enable means to make it easy to provide an incentive to a finder for facilitating the return of an item.

Lee, U.S. Pat. App. No. 2006/0265298 discloses a method of searching for a lost item using a credit card whereby the credit card number of the item owner is used to derive a unique identifier that is affixed to a lost item. However, it does not disclose an insurance offering associated with the method's use, nor does it disclose means to make it easy to provide an incentive to a finder for facilitating the return of an item, nor does it disclose means to make it easy for an item owner to obtain assurances that a lost-and-found service will be provided for an item if lost.

Biles, WO1999/018818A2 discloses methods for determining the unique identifier that is placed on a tag used in a lost-and-found service. However, it does not disclose an insurance offering associated with the method's use, nor does it disclose means to make it easy to provide an incentive to a finder for facilitating the return of an item, nor does it disclose means to make it easy for an item owner to obtain assurances that a lost-and-found service will be provided for an item if lost.

Hosp, WO2007/045992 discloses a system and method for tagging items, registering information about the tag and the item, and facilitating the return of the item if lost. However, it does not disclose an insurance offering associated with the system and/or method's use, nor does it disclose means to make it easy to provide an incentive to a finder for facilitating the return of an item, nor does it disclose means to make it easy for an item owner to obtain assurances that a lost-and-found service will be provided for an item if lost.

Burg, U.S. Pat. No. 7,135,977 and U.S. Pat. App No. 2006/0148443 disclose a method for registering an item online and printing a label at a distributed printing location, wherein the registry of items can be queried and each record in the registry contains a forwarding address to which information queries may be forwarded. However, they do not disclose an insurance offering associated with the method's use, nor do they disclose means to make it easy to provide an incentive to a finder for facilitating the return of an item, nor do they disclose means to make it easy for an item owner to obtain assurances that a lost-and-found service will be provided for an item if lost.

Elledge, U.S. Pat. App. No. 2007/0252697 discloses a system and method for tagging items, registering information about the tag and the item, and facilitating the return of the item if lost. In particular, it proposes use of an RFID which carries many of the same burdens as the bar code apparatus as aforementioned. Also, it does not disclose an insurance offering associated with the system and/or method's use, nor does it disclose means to make it easy to provide an incentive to a finder for facilitating the return of an item, nor does it disclose means to make it easy for an item owner to obtain assurances that a lost-and-found service will be provided for an item if lost.

McLaughlin, U.S. Pat. App. No. 2007/0214021 discloses a system and computer-enabled method for offering insurance on an item wherein an RFID reader is used to identify an insurable item, the identifier read on the item is associated with a consumer, and an offer of insurance is presented to the consumer. While McLaughlin presents the idea of offering insurance when an RFID tag is read, this has little practical applicability. Today, in stores like Circuit City and Best Buy, insurance is offered with the purchase of an item such as a cell phone or digital camera at the point-of-sale and/or time-of-sale, and no RFID-related process is required. McLaughlin does not describe a lost-and-found service as being offered as part of the sale of an insurance offering, nor does it disclose and enable means to make it easy to provide an incentive to a finder for facilitating the return of an item, nor does it disclose and enable means to make it easy for an item owner to obtain assurances that a lost-and-found service will be provided for an item if lost.

The problem remains that while insurance exists which provides some compensation to an item owner in the event of loss and/or theft of an item, it does not solve the problem of returning the data to the item's owner. Furthermore, the problem remains that lost-and-found service providers face difficulties when charging owners for return of a found item and/or rewarding an item finder for facilitating the return of a lost item. The notion of combining an insurance service with a lost-and-found service has not been disclosed and enabled in the prior art, nor has it been described and/or offered in the marketplace.

Another problem remains that known apparatuses and systems for returning lost items to their owners provide ambiguous or weak incentives for the finder to return items. Incentives for item finders who return the items are mentioned at a high level in the prior art, but the prior art lacks a method and apparatus for practically and realistically offering such an incentive.

Another problem relates to the purchase of a lost-and-found service, and means to make it easy for an item owner to purchase assurances that such a service will be provided for an item. In accordance with the various embodiments of the present invention, these assurances are preferably made to the item owner by the lost-and-found service provider in a retail environment in a fast and convenient manner.

### SUMMARY OF THE INVENTION

There exists a need for a system which provides insurance in the event of loss or theft of an item and provides means for preferably returning the lost item to the insured if the item that is lost and/or stolen is found. Such a system will improve the value to both the insurer and the insured, in that the insurer eliminates the cost of replacing lost and/or stolen items that are subsequently found and returned, and the insured has an opportunity to recover not only the insured item itself but also the data stored on his or her item.

There also exists a need for a lost-and-found system which charges item owners and/or insurers for facilitating the return of a found item, and/or provides an incentive to an item finder for facilitating the return of a lost item. The need exists for a lost-and-found system which does so in a streamlined and straightforward manner for all of the parties involved.

There also exists a need relative to the purchase of such a lost-and-found service, in particular means to make it easy for an item owner to purchase assurances that such a service will be provided for an item.

The present invention in one aspect comprises a system for providing insurance associated with a lost-and-found service. In accordance with a preferred embodiment of the present invention, a person and/or item (the “insured”) is covered by an insurance policy that provides compensation in the event of at least one of loss, theft, damage, and/or destruction of an item, and in association with said insurance, also receives one or more services that facilitate the return of the item if it is lost and/or stolen.

In accordance with another preferred embodiment of the present invention, the insurance policy pays for the facilitation of the return of an item if it is lost by the insured and subsequently found and reported to a lost-and-found service provider. The lost-and-found service provider may or may not be a provider of courier services and/or insurance services and/or other services.

In accordance with another preferred embodiment of the present invention, the insured person pays the insurance provider a deductible for the return of the previously insured item if it is lost and/or returned, and/or if a claim is made to the insurer and/or lost-and-found service provider. In another preferred embodiment of the present invention, a lost-and-found service provider is reimbursed by the insurance provider when an item is lost in exchange for providing the services of identifying the insured using unique markings contained on a lost item owned by the insured, contacting the person associated with the item, contacting the insurance service provider (which may or may not be the same as the lost-and-found service provider), and/or facilitating the return of the lost item to the owner or insurance provider.

In accordance with another preferred embodiment of the present invention, registering for an insurance policy also facilitates registering for the services of a lost-and-found service provider or vice versa. In a preferred embodiment of the present invention, when a person provides registration and/or application information for an insurance policy such as the person's name, address, contact preferences, item type, item value, shipping preferences, and/or other information, this information is also used to register the person for a lost-and-found service or vice versa, whereby a unique identifier associated with an item owner is stored with some or all of the other registration and/or application information. In this way, an item owner only has to provide information once in order to receive an insurance service and to receive a lost-and-found service.

In another aspect of the present invention, the price of the lost-and-found service is included as part of the price of the insurance service. In another aspect of the present invention, the price of a lost-and-found service is separate from and in addition to the price of the insurance service.

In another aspect of the present invention, upon purchasing insurance for loss and/or theft of an item, the insured person is provided with a tag and/or label to affix to the item in which the tag and/or label contains unique identifying information associated with the person's registration information. If the item is lost and returned, the unique identifying information on the tag and/or label is used to retrieve the person's registration information, and subsequently to facilitate the return of the item to its owner.

In another aspect of the present invention, the insurance policy specifies conditions in which it will provide some benefit to the item owner on the occurrence of events which may include but are not limited to: a) the item being lost and not returned, b) the item being lost and returned, in which the insurer pays some or all of the costs associated with such a return, c) theft of the item, and/or d) damage to the item. In another aspect of the present invention, the reimbursement to the insurance company may be offset all or in part by a deductible paid by the item owner if a claim is filed relative to the item.

In accordance with another aspect of the present invention, the cost of a combined purchase of the insurance policy and lost-and-found service is lower than the cost of the purchase of either the insurance policy or the lost-and-found service when each is purchased separately.

The various embodiments of the insurance and lost-and-found system and methods in accordance with the aspects of the present invention solve the problems associated with the known prior art. The insurance and lost-and-found system and methods in accordance with the various embodiments of the present invention have significant advantages to facilitate acceptance in the marketplace.

### BRIEF DESCRIPTION OF THE DRAWINGS

FIG. 1 is a top-level flowchart of a preferred embodiment of the system of the present invention.

FIG. 2 is a diagram of the determination function shown in FIG. 1.

FIG. 3 is a flowchart illustrating the terms and conditions of an insurance policy associated with a lost-and-found service.

FIG. 4 is a flowchart illustrating how an item owner may preferably purchase and/or register for an insurance policy associated with a lost-and-found service.

FIG. 5 is a flowchart illustrating how an insurance policy associated with a lost-and-found service may preferably provide and receive money from various parties in the event that an item is lost and returned.

FIG. 6 is a block diagram of a computer system for providing insurance associated with a lost-and-found system in accordance with an embodiment of the invention.

FIG. 7 is a block diagram of a computer having software for providing insurance associated with a lost-and-found system in accordance with an embodiment of the invention.

### DETAILED DESCRIPTION OF THE PREFERRED EMBODIMENTS

The present invention will be described in greater detail with respect to the preferred embodiments with reference to the drawing figures so as to exemplify the invention. Various alternatives, refinements, and substitutions will become readily apparent to persons skilled in the art based on the principles of the present invention illustrated herein.

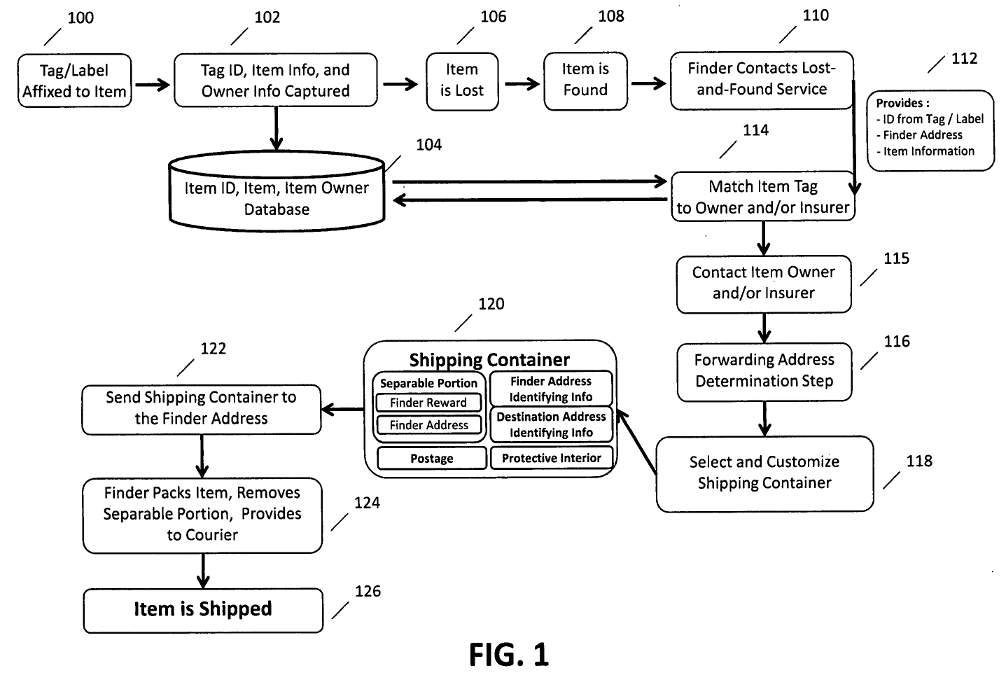

FIG. 1 is a flowchart of a preferred method that a lost-and-found service provider may use to facilitate the return of a lost item to its owner. Beginning in a step 100, a tag and/or label is affixed to an item, the label or tag containing unique identifying information. In a step 102, the unique identifying information on the tag and/or label is captured in a database 104 with records for a plurality of tags and/or labels, wherein a tag and/or label and its unique identifying information corresponds to one or more records in the database 104 containing a variety of information about the item and/or its owner. In a step 106, the tagged and/or labeled item is lost by an owner or possessor, and in a step 108 the item is subsequently found by another party.

In a step 110, using the directions on the tag and/or label, the finder of the item (“item finder”) contacts a lost-and-found service provider and provides in a step 112 information to the lost-and-found service such as the identifying information from the tag and/or label, the address of the finder in order to facilitate subsequent steps in the method, and information about the found item such as its size, weight, type, etc. This information can be used in a step 118 to ensure that the lost-and-found service provider properly selects and customizes an appropriate shipping container in step 118 to facilitate the return of the item.

In a step 114, the identifying information provided by the item finder in step 112 is used specifically to identify item information and item owner information from the database 104, preferably including item owner address and item owner contact information. This information retrieved in step 114 may also include information about insurance on the item against loss or theft. Preferably, insurance information retrieved about the item includes one or more of the following: whether or not the item is insured, the terms of the theft or loss insurance, whether the insurance will pay any incentive to the finder for the return of the item, and/or whether the insurance will pay any shipping and/or other fees for the return of the item.

In a step 115, the lost-and-found service provider contacts the item owner and/or insurer if the item is insured against loss or theft. In this step, the lost-and-found service provider preferably seeks to achieve one or more of the following: a) notify the owner and/or insurer, if applicable, that the item has been found and thus does not necessarily need to be replaced, b) obtain payment means in order to pay the lost-and-found service provider for processing and fees related to returning the item such as, by way of example: shipping fees, incentive fees for the finder, processing fees, deductible payments, etc., c) verify the proper return address for the item, and/or d) determine whether or not the item owner and/or insurer wants the item returned, thus potentially incurring costs associated with return, or whether the owner and/or insurer prefer that the item be discarded, thus possibly avoiding said costs.

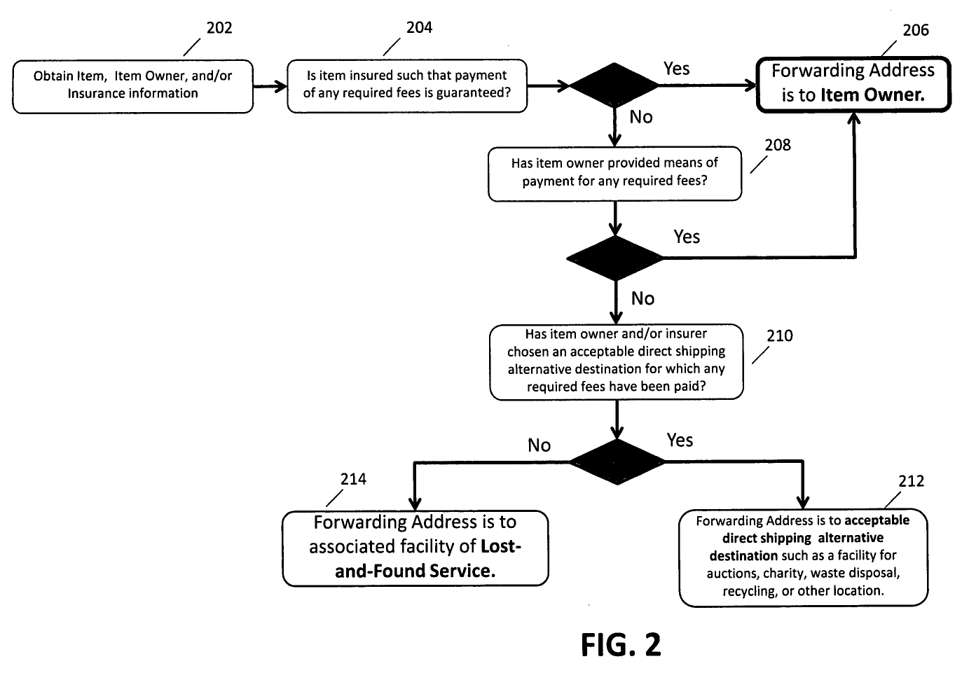

In a step 116, the lost-and-found service provider determines the proper forwarding address to which the item will be sent, and thus the address which must be printed and/or otherwise affixed to the shipping container 120 in step 118. FIG. 2 is a detailed flowchart describing the logic for this determination step 118. There are a variety of destinations to which the shipping container 120 can be forwarded including but not limited to: a) the item owner, b) a facility of a lost-and-found service provider for subsequent processing and/or storage, c) an auction service, d) a charitable organization, e) a disposal facility, and/or f) a recycling facility. The selection of the forwarding address is preferably determined in step 118 as shown in FIG. 2.

Referring now to FIG. 2, a computer-enabled system determines the forwarding address which is pre-printed and/or affixed to the shipping container 120. The forwarding address is the address to which the shipping container 120 will be sent after the item finder has inserted the item into the protective interior of the shipping container 120.

The goals of the determination step 118 in FIGS. 1 and 2 are to: a) minimize logistics costs, b) assure that payment means exists to compensate for the return of the item to the item owner including such fees as an incentive to the item finder for returning the item, processing fees, shipping fees, and/or other fees, c) in the case that an item owner and/or insurer does not wish the item be returned to its owner, minimize costs in enabling the proper handling of the item, and d) in the case that an item owner and/or insurer may want the item returned but has not provided any required payment for its return, enable intermediate processing by a lost-and-found service provider.

In a step 202, information including but not limited to information about the found item, its owner, and insurance that reimburses the owner against loss of the item is identified as described previously in FIG. 1 and its accompanying description. In a step 204, a determination is made as to whether or not the item is insured such that any fees associated with returning the item to its owner, such as incentive fees for the item finder, shipping fees, deductibles, and/or processing fees, are guaranteed to be paid to the lost-and-found service provider and/or other entities in exchange for returning the item to the item owner. If the determination is yes, in a step 206 the forwarding address is determined to be the address of the item owner.

If the answer is no, in a step 208 a determination is made such that any fees associated with returning the item to its owner, such as incentive fees for the item finder, shipping fees, deductibles, and/or processing fees, are guaranteed to be paid to the lost-and-found service provider and/or other entities in exchange for returning the item to the item owner. If the answer is yes, in step 206 the forwarding address is determined to be the address of the item owner.

If the answer to the determination made in step 208 is no, in a step 210 a determination is made as to whether the item owner and/or insurer has indicated an “acceptable direct shipping alternative” to having the item returned to the item owner. An “acceptable direct shipping alternative” is an alternative destination for which fees required by the lost-and-found service provider, if any, have been paid and/or to which the lost-and-found service provider has agreed to ship the item directly using the shipping container 120. By way of example, a lost-and-found service provider may agree to waive fees on any shipping and/or processing of a found item in exchange for rights to auction the item and profit from some percentage of the auction. In step 210, should an item owner and/or insurer agree to auction a found item rather than return it to its owner, and should an auction facility appropriate for auctioning the item be an acceptable direct shipping alternative destination per the lost-and-found service, in a step 212 the lost-and-found service provider may ship the lost item directly to an auction service.

In step 210, if the item owner and/or insurer has not chosen an acceptable direct shipping alternative destination, than in a step 214 the forwarding address is to an associated facility of a lost-and-found service provider. The associated facility of a lost-and-found service provider is any facility that assists in the shipping and/or other processing of a lost and/or found item. Shipping the item to an associated facility of a lost-and-found service provider enables said provider to perform additional processing steps, by way of example, including but not limited to: a) trying to obtain payment of any required fees from the item owner and/or insurer, b) disposing of the item, c) recycling the item, d) auctioning the item, e) forwarding the item to its owner, f) donating the item to a public service and/or community organization such as a police station, and/or g) otherwise processing the item.

The method illustrated in FIG. 2 has the advantages of enabling: a) shipping the item directly from the item finder to the item owner if requisite fees have been paid by the insurer and/or item owner, b) shipping the item directly from the item finder to an acceptable alternative destination, if appropriate, without intermediate processing by the lost-and-found service provider, and c) enabling the finder to conveniently and inexpensively forward the item if the item's final destination has not been determined at the time of preparation of the shipping container 120.

Referring now again to FIG. 1, in step 118, a shipping container 120 is selected and customized by an entity which may include but is not limited to a lost-and-found service provider, a courier service (which may itself be a lost-and-found service provider), a fulfillment service provider, or other entity. A shipping container 120 may be selected from a variety of shipping containers 120 with various sizes, weights, protective characteristics, reward means for finders, courier charges such as postage, finder addresses, forwarding addresses, and other characteristics. The selection and/or customization of the shipping container 120 performed in step 118 is based on a variety of factors including but not limited to, individually or in combination: a) the fragility of the item per information gathered in one or more of steps 112, 114, and/or 115, thus determining the protective characteristics of the shipping container 120, b) the size and/or weight of the item per information gathered in one or more of steps 112, 114, and/or 115, thus determining characteristics of the shipping container 120 such as postage or other courier charges, size, packaging strength, and protective characteristics, c) the reward offered as an incentive to the finder for returning the item as gathered in one or more of steps 112, 114, and/or 115, d) the forwarding address determined in the address determination step 116 to which a separable portion of the shipping container can be sent after the item is enclosed in the shipping container 120 by the item finder, and e) the finder address gathered in step 112. These factors determine the selection and/or customization of the shipping container 120 in step 118.

In a step 122, a lost-and-found service provider, courier service, fulfillment service, and/or other entity sends a shipping container 120 to the item finder at the finder address collected in step 112, the shipping container having the characteristics determined in step 118. In a step 124, the item finder inserts the item into a protective interior of the shipping container 120 and preferably removes a separable portion of the shipping container containing the finder's address, incentives to the item finder for returning the item, advertising information, and/or other information, and seals the protective interior of the shipping container 120 with the found item enclosed. Continuing step 124, the item finder returns the shipping container 120 to a courier such as the U.S. Postal Service, Federal Express, or UPS. In a step 126, the forwarding address determined in step 116 becomes the operative address to inform the return of the item by a courier to the proper destination.

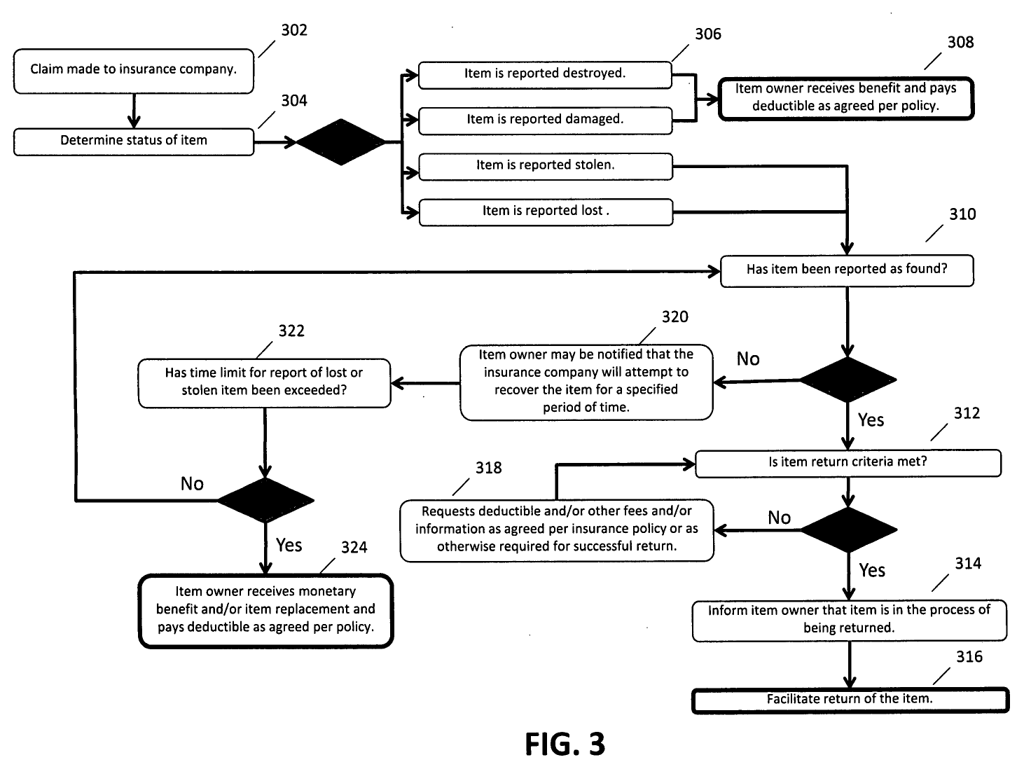

FIGS. 1 and 2 describe a lost-and-found service associated with an insurance service. Referring now to FIG. 3, a flowchart illustrating the preferred embodiment of an insurance policy associated with a lost-and-found service is shown.

In a step 302, an item owner who has insured an item (“insured”) contacts the provider of an insurance policy (“insurance company”, “insurer”, “insurance service provider”, or “lost-and-found service provider”) to make a claim regarding the item. In accordance with a preferred embodiment of the present invention, the insurance policy has the following characteristics:
Provides a benefit to the insured in the event of loss, theft, damage, defect, and/or destruction of one or more items owned and/or in the care of the person and/or entity;
By way of example, the one or more items may be items including but not limited to laptop computers, mobile phones, personal digital assistants, portable gaming devices, cameras, sunglasses, jewelry, personal music players, personal video players, and/or any other device prone to loss, theft, damage, defect, and/or destruction;
In the event of damage, defect, and/or destruction of an insured item, upon receiving a claim as described in step 302, the insurance company provides a benefit to the insured which may include but is not limited to replacement of the insured item with a similar or equivalent item and/or providing monetary compensation in an amount associated with the value of the insured item;
In the event of loss and/or theft of an item, upon receiving a claim as described in step 302, the insurance company provides a benefit which may include but is not limited to: a) replacing the insured item with a similar or equivalent item and/or providing monetary compensation in an amount associated with the value of the insured item or b) if the lost or stolen item is reported as found by an item finder, paying for and/or facilitating the return of the original item to its owner;
The insurance company may collect a deductible payment from the item owner in the event that one of the aforementioned claims is made, where the deductible payment may or may not vary depending on the type of claim made relative to the item and/or the status of the item.
   In a step 304, the insurance company determines the status of the one or more insured items associated with the claim, in which the status may include but is not limited to in a step 306 determining that the item has been destroyed, the item is damaged, the item is stolen, and/or the item is lost. In a step 308, if the item is reported destroyed and/or damaged, in step 308 the item owner and/or insured receives the benefit specified by the insurance policy and pays the deductible as agreed per the policy.

In step 306, if the item is reported stolen or lost, then a determination is made as to whether or not the item has been reported found in a step 310. In accordance with a preferred embodiment of the present invention, an affirmative answer relative to step 310 in FIG. 3 coincides with step 110 shown in FIG. 1, in which the item finder contacts the lost-and-found service provider and reports the item as found.

If the item has been reported as found in step 310, in a step 312 shown in FG. 3, a determination is made as to whether or not item return criteria have been met. In accordance with a preferred embodiment of the present invention, item return criteria are whether the insured person has paid any deductible associated with the claim, and whether the insured person has provided a current return address to which the item can be returned. However, other item return criteria may include but are not limited to whether the item owner has been successfully contacted, whether the item owner has paid shipping and/or other fees associated with the return of the item, and/or whether the item owner has made claims in the past associated with the insured item. Provided that the item return criteria have been met in step 312, in a step 314 the item owner is informed by a lost-and-found service provider and/or the insurance company that the item is in the process of being returned. In a step 316, the lost-and-found service provider and/or the insurance company facilitates the return of the item using processes and means described above with reference to FIGS. 1 and 2.

If item return criteria have been met, in a step 318, the insurance company and/or lost-and-found service provider and/or other service provider requests information and/or payment from the item owner and/or other parties as agreed per the insurance policy or as otherwise required in order to meet the item return criteria. In step 312, if the return criteria are again not met, requests are repeated in a step 318 for payment and/or other information to meet the item return criteria.

The method described in FIG. 3 executes different actions from step 310 if the item has not been reported as found. In this case, in a step 320 in accordance with a preferred embodiment of the present invention, the item owner is notified that the insurance company will attempt to recover the item for a specified period of time. In a preferred embodiment of the present invention, the specified period of time is explicitly communicated to the item owner so that the item owner knows when he or she may purchase and/or expect a replacement for the lost or stolen item, paid for all or in part by the insurance company. The specified period provides time for an item finder to find and report the finding of the item before the item owner and/or insurance company pays for a replacement. In a preferred embodiment of the present invention, the specified period of time is specified in the terms and conditions of the insurance policy, and is measured relative to the time at which an item owner makes a claim in step 302.

In a step 322, a determination is made as to whether the specified time has been exceeded. If the specified period of time has been exceeded, in a step 324 as per the insurance policy, the item owner receives a monetary benefit and/or item replacement and pays any deductible as agreed per the insurance policy. In step 322, if the specified period of time has not been exceeded, more time is permitted to elapse such that the item may eventually be found and reported in step 310, thus helping the insurance company save money that would be required to compensate for replacement of the lost or stolen item, and benefiting the item owner by allowing him or her to recover the original item along with any valuable data stored on it.

A complication could arise in the system after step 324, at which point, as per the insurance policy, the item owner receives a monetary benefit and/or item replacement and pays any deductible as agreed per the insurance policy. The complication could occur if said monetary benefit and/or item replacement occurs, but at a subsequent time the item is found and reported to the lost-and-found service provider. In accordance with a preferred embodiment of the present invention, should this occur, a computer- and software-enabled system of the lost-and-found service provider retrieves the item owner information via a query using the unique identifying information on the found item, and provides an automated interface via email and/or phone by which the item owner can select whether or not to have the item returned to the item owner, and/or otherwise disposed of and/or auctioned and/or sold. In accordance with a preferred embodiment of the present invention, the item owner is required to pay a fee in order to have the item returned to the item owner, and fee payment means is provided via a computer-enabled automated interface over the phone and/or Internet as known to those skilled in the art. If the item owner declines to pay said fee, and/or if a specified amount of time elapses during which the item owner has not paid said fee, the lost-and-found service provider may dispose of, auction, recycle, donate, or relinquish control of the item as appropriate. In another preferred embodiment of the present invention, the item owner may choose the disposal means for the found item if relinquishing a claim to the found item. In another preferred embodiment of the present invention, the item owner may choose to donate some or all of the proceeds for the sale and/or auction of the found item to charity after relinquishing the claim to the found item, and/or may donate the found item to a charitable organization.

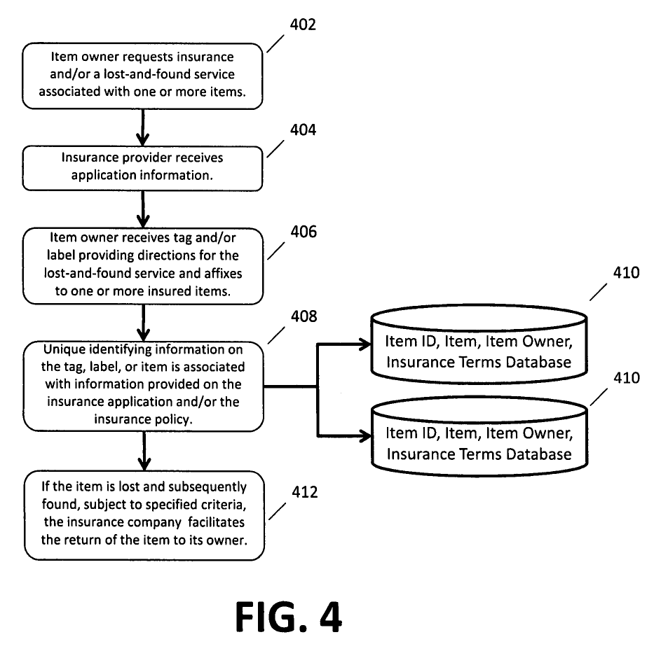

Referring now to FIG. 4, a flowchart illustrates a preferred embodiment of the present invention disclosing how an item owner may preferably purchase and register for an insurance policy associated with a lost-and-found service. In a step 402, the item owner requests insurance and/or a lost-and-found service associated with one or more items. In a preferred embodiment, the request may by prompted by a solicitation made at a retail point-of-sale, for instance at a Circuit City retail store, after a customer has selected an item for purchase. In another preferred embodiment, the request may be prompted by an online solicitation made after a customer has selected an item for purchase from an online retail store. In another preferred embodiment, the request may be in response to a solicitation at the time of and/or following registration of the purchased item with the lost-and-found service provider. In another preferred embodiment, the cost of a combined purchase of the insurance policy and lost-and-found service is lower than the cost of the purchase of either the insurance policy or the lost-and-found service when each is purchased separately.

In a step 404, the insurance company receives information required in order to complete an insurance application. In accordance with a preferred embodiment of the present invention, information stored in a database by the retailer is provided in order to complete, wholly or in part, the insurance application. The retailer's database may be a database that supports a customer loyalty program and/or an online ordering process. In an alternative preferred embodiment of the present invention, the item owner completes a registration card that contains information required in order to complete an insurance application. In another preferred embodiment of the present invention, the item owner completes a registration card at the point-of-sale which is associated with an adhesive sticker, wherein the sticker may be applied to an item, and wherein the registration card and adhesive sticker share common identifying information.

In a step 406, after the insurance company receives the application information, the unique identifying information stored on the tag, label, and/or on the item itself is stored in one or more databases 410 which in step 408 enable the association of the unique identifying information on the item and/or the tag and/or the label to be associated with information about the item, the item owner, and/or the related insurance policy. In a preferred embodiment of the present invention, all of the aforementioned information is stored on a single, common database 410. However, it is also contemplated that the information may be stored in multiple databases 410, possibly under the management of multiple organizations, such as a scenario when one database 410 is controlled by an insurance company and another database 410 is controlled by a lost-and-found service provider. In accordance with a preferred embodiment of the present invention, use of primary keys or other means known to those skilled in the art can create associations between such records stored in disparate databases 410.

In a step 412, if the item is lost and subsequently found, subject to criteria specified in the insurance policy, the insurance company facilitates the return of the item to its owner. In accordance with a preferred embodiment of the present invention, the insurance company facilitates the return of the item to its owner by paying costs associated with having a lost-and-found service provider recover the item from the item finder and subsequently provide for the delivery of the item to its owner, and also paying any incentive promised to the item finder as a reward.

In accordance with a preferred embodiment of the present invention, the criteria specified in the insurance policy include: a) that the insurance company has not already compensated the item owner for the claim associated with the lost or stolen item and b) that the item owner has paid any deductible required per the insurance policy for the return of the item. Other policy criteria may also be considered before the insurance company agrees to facilitate the return of the item to its owner as earlier described.

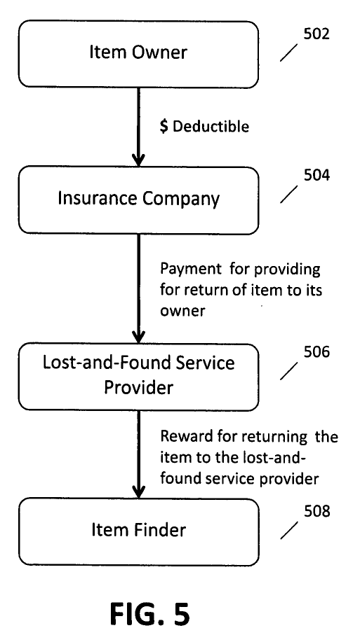

Referring now to FIG. 5, a diagram shows a preferred embodiment of the present invention describing how the various parties exchange compensation in facilitating the return of a lost item to its owner in association with an insurance policy. The item owner 502 can be any person and/or entity that owns an item, controls an item, has a prioritized interest in an item, manages an item, has claim to possession of an item, and/or has an insurance policy relative to an item in which the insurance company 504 provides a benefit to the item owner in the event the item is lost, stolen, damaged, and/or destroyed (an “insured event”). The insurance company is any person or entity that provides a benefit to the insured in the event that a claim is filed relative to one or more of the aforementioned insured events.

In accordance with a preferred embodiment of the present invention, in the event of a claim of loss or theft of an item which is subsequently found and needs to be returned to the item owner 502, the item owner 502 may provide a deductible to the insurance company 504 per the terms of the insurance policy. The insurance company in turn provides a payment to a lost-and-found service provider 506 in exchange for the lost-and-found service provider 506 providing for the return of the found item to the item owner 502. FIG. 1 describes a preferred system and method for returning a found item to the item owner 502.

In accordance with a preferred embodiment of the present invention, the person and/or entity that found the item that was lost or stolen (“item finder” 508) receives a reward from the lost-and-found service provider 506 in exchange for returning the item to the owner or lost-and-found service provider 506.

It should be noted that in accordance with one preferred embodiment of the present invention, the lost-and-found service provider 506 may be the same entity as the insurance company 504. In this scenario, the payment for providing for the return of an item to its owner 502 may be completed via an internal transaction record in which no money or compensation leaves the bounds of the combined lost-and-found service provider 506/insurance company 504.

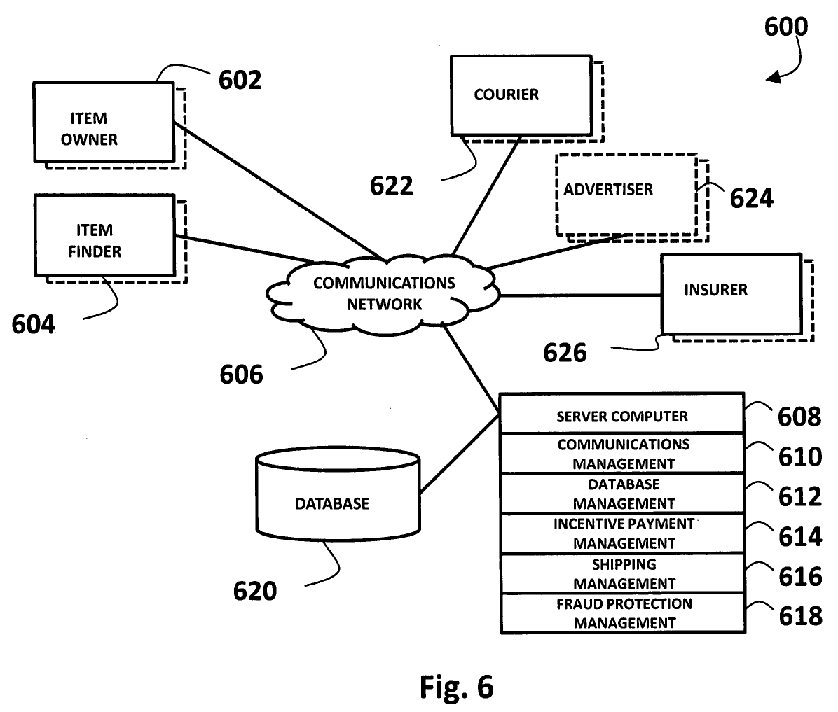

FIG. 6 is a block diagram of a computer system for providing insurance associated with a lost-and-found system in accordance with an embodiment of the present invention. In one embodiment, computer system 600 includes an item owner 602; an item finder 604; a communications network 606; a server computer 608 having a communications management component 610, a database management component 612, an incentive payment management component 614, a shipping management component 616, and a fraud protection management component 618; a database 620; a courier 622; an advertiser 624; and an insurer 626. The item owner 602, the item finder 604, the courier 622, the advertiser 624, and the insurer 626 are communicatably linked with the server computer 608 over the communications network 606. The server computer 608 is communicatably linked with the database 620. Any of the elements of FIG. 6 can be eliminated or distributed.

In one embodiment, the server computer 608 implements one or more embodiments of the systems and methods described in reference to FIGS. 1-5. Accordingly, in one particular embodiment, the item owner 602 couples a tag and/or label having identifying information to an item. The identifying information of the tag and/or label is associated with the item owner 602 in the database 620. When the item is found by the item finder 604, the item finder 604 provides the server computer 608 the identifying information over the communications network 606. The communications management component 610 receives the identifying information, and the database management component 612 determines the item owner 602 and the incentive payment information in the database 620. The communications management component 610 notifies the item owner of the found status of the item, and the incentive payment management component 614 ensures that the incentive payment is satisfied by the item owner 602 and/or the insurer 626. Upon satisfaction of the incentive payment, the shipping management component 616 of the server computer prepares the incentive payment, packaging, and labels for sending to the item finder 604. When the item finder 604 receives the incentive payment and packaging, the item finder 604 retains the incentive payment, inserts the item into the packaging, and forwards the item to the item owner 602 using the courier 622. Upon receipt of the item by the item owner 602, the fraud protection management component 618 activates the incentive payment. The advertiser 624 optionally provides coupons or discounts to the item finder 604 as a substitute for the incentive payment when such incentive payment is not satisfied.

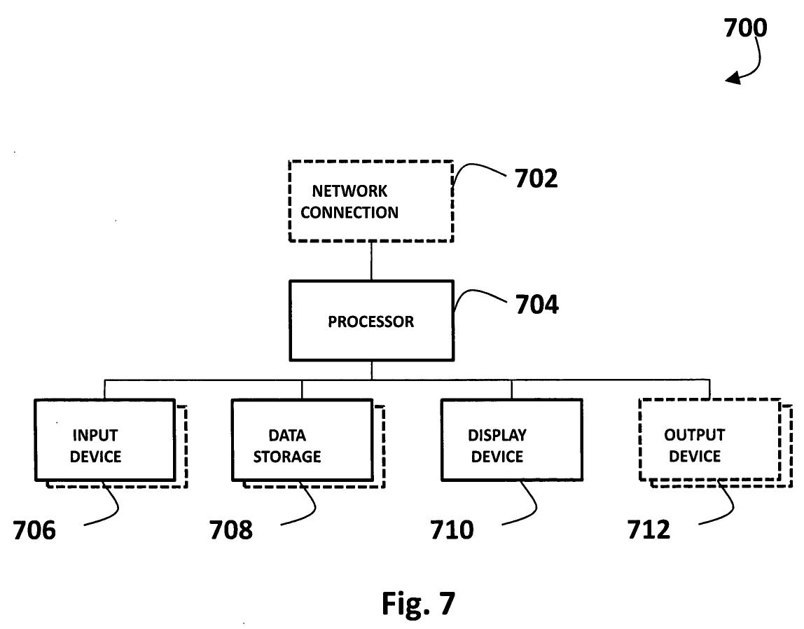

FIG. 7 is a block diagram of a computer having software for providing insurance associated with a lost-and-found system in accordance with an embodiment of the present invention. In one embodiment, the computer having software 700 includes a network connection 702, a processor 704, an input device 706, data storage 708, a display device 710, and an output device 712.

In one embodiment, the computer having software 700 is configurable to implement one or more embodiments of the systems and methods described in reference to FIGS. 1-6. Accordingly, in one particular embodiment, the processor 704 receives notice of a found item over the network connection 702 that includes identifying information from a tag and/or label on a found item. The processor 704 accesses the data storage 708 and determines owner information for the found item using the identifying information from the tag and/or label. The owner information includes owner contact information, incentive payment information, and insurance information and may be displayed on the display device 710. The processor 704 informs the item owner over the network connection 702 that the item has been found, verifies owner contact information, confirms the identity of the item, and confirms that the owner wants the item returned. The processor 704 determines whether the incentive payment has been prepaid and if not, whether the owner or any insurance provider is responsible for any unpaid incentive payment. If the incentive payment is unpaid, the processor 704 contacts the item owner or any insurance provider to collect the incentive payment. Upon the incentive payment being satisfied, the processor 704 prepares the incentive payment, labels, and packaging using the output device 712. When the item is successfully received by the item owner, the processor 704 then activates the incentive payment over the network connection 702.

While the foregoing description has been with reference to particular embodiments of the present invention, it will be appreciated by those skilled in the art that changes in these embodiments may be made without departing from the principles and spirit of the invention. Accordingly, the scope of the present invention can only be ascertained with reference to the appended claims.

What is claimed is:

1. A method for an item owner to purchase and register for an insurance policy associated with a lost-and-found service, comprising the steps of:
enabling the item owner to request insurance and a lost-and-found service associated with one or more items, the request being prompted by a solicitation made at a retail point-of-sale after a customer has selected an item for purchase or the request being prompted by an online solicitation made after a customer has selected an item for purchase from an online retail store or the request being prompted in response to a solicitation at the time of and/or following registration of the purchased item with the lost-and-found service provider;
receiving information by an insurance company required in order to complete an insurance application;
after the insurance company receives the application information, storing unique identifying information applied to the item in one or more databases which enable the association of unique identifying information on the item to be associated with information about the item, the item owner, and the related insurance policy; and
if the item is lost and subsequently found, facilitating return of the item to its owner subject to criteria specified in an insurance policy;

2. The method of claim 1 wherein the item owner completes a registration card that contains information required in order to complete an insurance application.

3. The method of claim 1 wherein the item owner completes a registration card at the point-of-sale which is associated with an adhesive sticker, wherein the sticker is applied to an item, and wherein the registration card and adhesive sticker share common identifying information.

4. The method of claim 1 wherein the information required in order to complete the insurance application is stored in a database by a retailer and is provided in order to complete, wholly or in part, the insurance application.

5. The method of claim 1 wherein the unique identifying information is stored in multiple databases under the management of multiple organizations, respectively, wherein one database is controlled by the insurance company and another database is controlled by a lost-and-found service provider.

6. The method of claim 1 wherein the insurance company facilitates the return of the item to its owner by paying costs associated with having a lost-and-found service provider recover the item from an item finder and subsequently providing for the delivery of the item to its owner, and also paying any incentive promised to the item finder as a reward.

7. The method of claim 1 wherein the criteria specified in the insurance policy include: a) that the insurance company has not already compensated the item owner for a claim associated with the lost or stolen item and b) that the item owner has paid any deductible required per the insurance policy for the return of the item.
